(19) United States
(12) Patent Application Publication
(10) Pub. No.: US 2009/0213436 A1
(43) Pub. Date: Aug. 27, 2009

(54) IMAGE PROCESSING APPARATUS, OPERATION SUPPORT METHOD, AND OPERATION SUPPORT PROGRAM

(75) Inventor: Noriyuki Takuwa, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/394,984

(22) Filed: Feb. 27, 2009

Related U.S. Application Data
(60) Provisional application No. 61/032,040, filed on Feb. 27, 2008.

(51) Int. Cl. H04N 1/32

(52) U.S. Cl. 358/442

(57) ABSTRACT

To provide a technique that can maintain satisfactory operability with a simple configuration regardless of brightness of an environment in which an image processing apparatus is set. The image processing apparatus includes an operation input section that receives an operation input of a user, a supporting member that supports the operation input section in a position away from an apparatus main body, and a light source that is supported together with the operation input section by the supporting member and illuminates an area for work by the user in the apparatus main body.

### CROSS-REFERENCE TO RELATED APPLICATION

This application is based upon and claims the benefit of priority from U.S. provisional application 61/032,040, filed on Feb. 27, 2008, the entire contents of which is incorporated herein by reference.

### TECHNICAL FIELD

The present invention relates to a technique for illuminating an area for work by a user in an image processing apparatus.

### BACKGROUND

In the past, concerning an operation panel having a role of a user interface in an image processing apparatus, there are known an operation panel integrally formed with an apparatus main body and an operation panel unit supported by a column fixed to the apparatus main body.

In the image processing apparatus having such a configuration, even when the image processing apparatus is set in a place where sufficient light does not reach such as a corner of a room, since the operation panel itself is illuminated by a backlight or the like, visibility is not so spoiled.

However, since sections other than the operation panel such as a document placing table and a paper discharge tray are not illuminated by the backlight or the like, the sections tend to be affected by light and shade of a setting environment. In particular, when the image processing apparatus is set in the place where sufficient illumination light does not reach, work efficiency falls because a user cannot see his or her hand well in supplying sheets and original documents or taking out processed sheets from the apparatus.

### SUMMARY

It is an object of an embodiment of the present invention to provide a technique that can maintain satisfactory operability with a simple configuration regardless of light and shade of an environment in which an image processing apparatus is set.

In order to solve the problems, according to an aspect of the present invention, there is provided an image processing apparatus including: an operation input section that receives an operation input of a user; a supporting member that supports the operation input section in a position away from an apparatus main body; and a light source that is supported together with the operation input section by the supporting member and illuminates an area for work by the user in the apparatus main body.

According to another aspect of the present invention, there is provided an operation support method in an image processing apparatus including an operation input section that receives an operation input of a user, a supporting member that supports the operation input section in a position away from an apparatus main body, and a light source that is supported together with the operation input section by the supporting member and illuminates an area for work by the user in the apparatus main body, the method including: discriminating content of processing executed in the image processing apparatus; and causing a light source associated with an area for work related to the discriminated processing to emit light.

According to still another aspect of the present invention, there is provided an operation support program for causing a computer to execute an operation support method in an image processing apparatus including an operation input section that receives an operation input of a user, a supporting member that supports the operation input section in a position away from an apparatus main body, and a light source that is supported together with the operation input section by the supporting member and illuminates an area for work by the user in the apparatus main body, the program causing the computer to execute processing for: discriminating content of processing executed in the image processing apparatus; and causing a light source associated with an area for work related to the discriminated processing to emit light.

### DESCRIPTION OF THE DRAWINGS

FIG. 1 is a schematic diagram for explaining an image processing apparatus according to a first embodiment of the present invention;

FIG. 2 is a schematic perspective view of a configuration of the image processing apparatus according to the first embodiment;

FIG. 3 is a longitudinal sectional view of a schematic configuration of the image processing apparatus according to the first embodiment;

FIG. 4 is a diagram for explaining details of an operation input unit 1a in the first embodiment;

FIG. 5 is a functional block diagram for explaining the image processing apparatus according to the first embodiment;

FIG. 6 is a flowchart for explaining a flow of processing (an operation support method) in the image processing apparatus according to the first embodiment;

FIG. 7 is a diagram of a state in which the vicinity of a document placing table Rt of an image scanning unit R is illuminated by light irradiated from a light source La;

FIG. 8 is a diagram for explaining details of an operation input unit 1b in a second embodiment of the present invention;

FIG. 9 is a diagram of a state in which the vicinity of a discharge tray 8 of the image forming unit P is illuminated by light irradiated from a light source unit 102b;

FIG. 10 is a diagram for explaining details of an operation input unit 1c in a third embodiment of the present invention;

FIG. 11 is a diagram of a state in which the vicinity of a discharge tray Ft of a post-processing apparatus F is illuminated by light irradiated from a light source unit 102c;

FIG. 12 is a diagram for explaining details of an operation input unit id in a fourth embodiment of the present invention;

FIG. 13 is a functional block diagram for explaining a configuration of an image processing apparatus according to the fourth embodiment;

FIG. 14 is a flowchart of a flow of processing (an operation support method) in the image processing apparatus according to the fourth embodiment;

FIG. 15 is a diagram of an example of a data table in which a correspondence relation among processing content discriminated by a processing discriminating unit 701, a processing state, a light source that should be caused to emit light, and a light emission pattern is set; and

FIG. 16 is a diagram of a state in which all areas for work are illuminated by lights irradiated from the light source unit 102c and a light source unit 102d.

### DETAILED DESCRIPTION

Embodiments of the present invention are explained below with reference to the accompanying drawings.

### First Embodiment

First, a first embodiment of the present invention is explained.

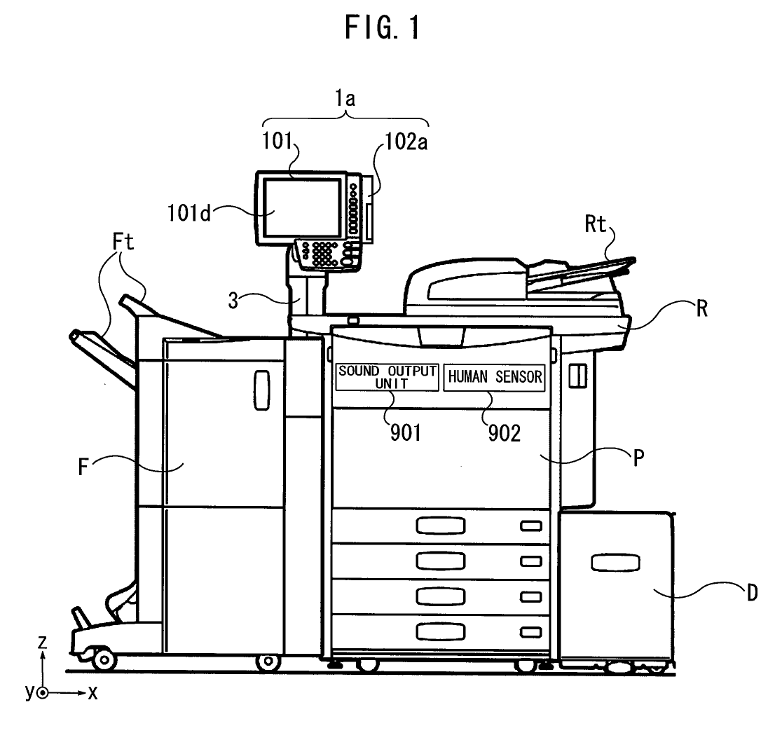

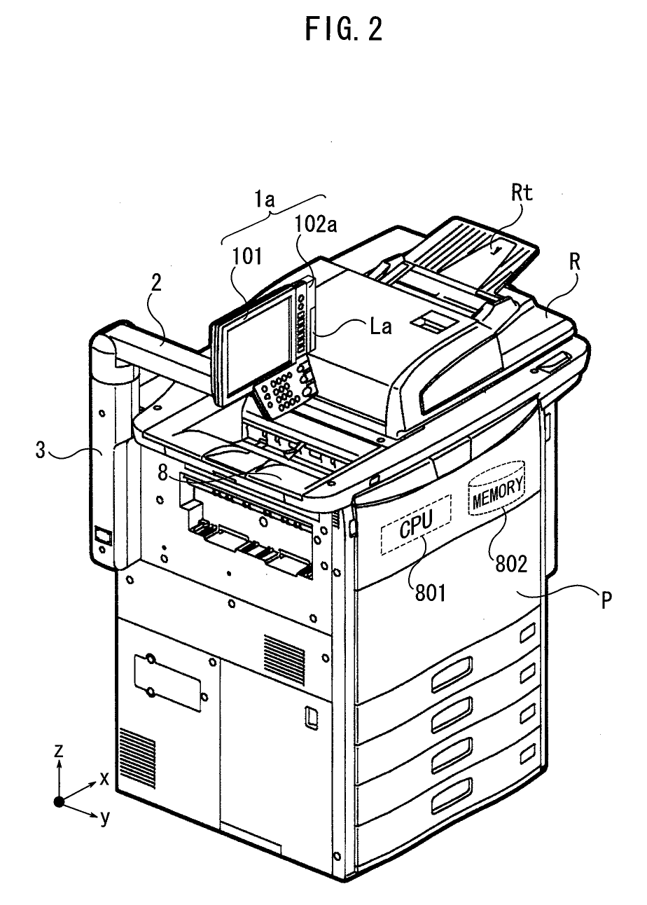

FIG. 1 is a schematic diagram for explaining an image processing apparatus (MFP: Multi Function Peripheral) according to the first embodiment. FIG. 2 is a schematic perspective view for explaining a configuration of the image processing apparatus according to the first embodiment.

As shown in FIG. 1, the image processing apparatus according to the first embodiment includes an image scanning unit R, an image forming unit P, an operation input unit 1a, a supporting member 2, a supporting member 3, a large-capacity paper feeding apparatus D, and a post-processing apparatus F.

The large-capacity paper feeding apparatus D can feed a large number of (e.g., several thousands) sheets as recording media to the image forming unit P.

The post-processing apparatus F applies predetermined post-processing to a sheet subjected to image formation processing by the image forming unit P. Specifically, the image formation processing apparatus F applies so-called “post-processing (finishing)” such as stapling, folding, punching, and bookbinding to the sheet subjected to predetermined image formation processing by the image forming unit P and discharges the sheet subjected to the post-processing onto a discharge tray Ft.

As shown in FIG. 2, the image processing apparatus according to this embodiment includes the supporting member 3 that is fixed to an apparatus main body at a proximal end thereof and extends to above the apparatus and the supporting member 2 that is rotatably coupled to a distal end of the supporting member 3 and has a role of an arm.

The operation input unit 1a is supported to separate from the apparatus main body by the supporting member 2 and the supporting member 3 (both the supporting members 2 and 3 correspond to the supporting member of the present invention).

Since the operation input unit 1a is supported above the apparatus main body by such a supporting mechanism, a user who uses the image processing apparatus according to this embodiment can adjust the position of the operation input unit 1a to obtain best operability for the user.

In this example of the configuration, the supporting member 3 extends to above the apparatus. However, the present invention is not limited to this. The entirety or a part of at least one of the supporting member 2 and the supporting member 3 may extend to above the apparatus.

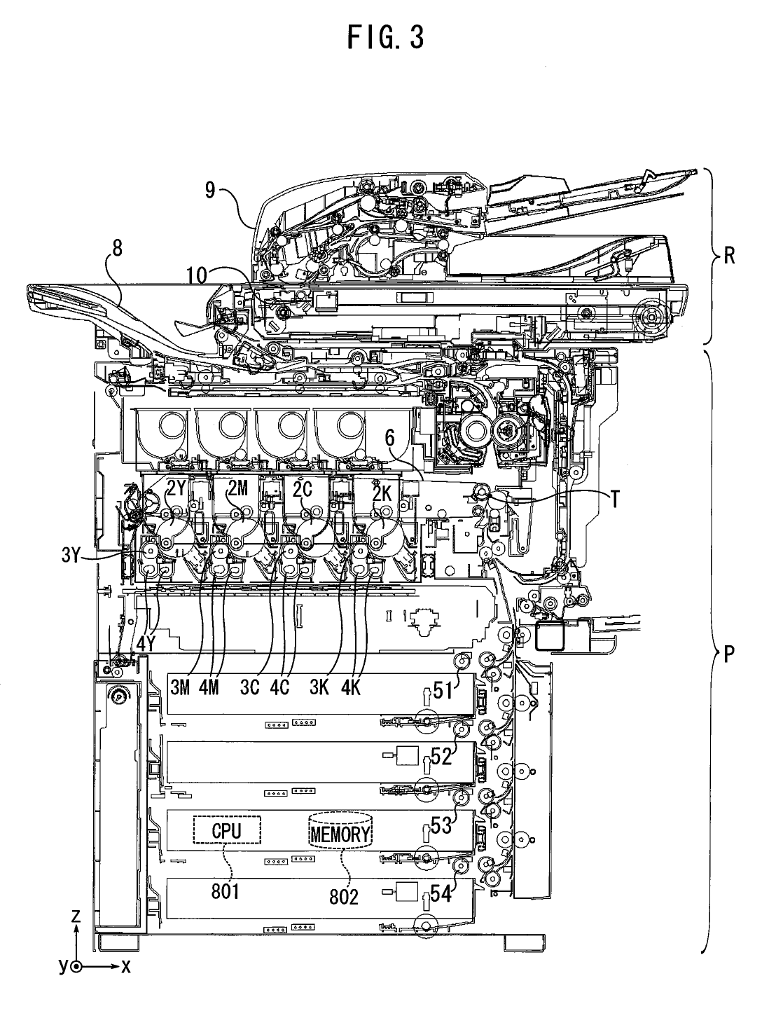

FIG. 3 is a longitudinal sectional view of a schematic configuration of an image scanning unit and an image forming unit in the first embodiment.

As shown in FIG. 3, the image processing apparatus according to this embodiment includes an image scanning unit R and an image forming unit P.

The image scanning unit R has a function of scanning an image of a sheet original document and a book original document.

The image forming unit P has a function of forming a developer image on a sheet on the basis of an image scanned from an original document by the image scanning unit R, image data transmitted from an external apparatus to the image processing apparatus, and the like.

The image scanning unit R includes an auto document feeder (ADF) 9 that can automatically feed an original document to a predetermined image scanning position. The image scanning unit R scans, with a scanning optical system 10, images of an original document placed on a document tray (a predetermined document placing table) Rt and automatically fed by the auto document feeder 9 and an original document placed on a not-shown document table.

The image forming unit P includes pickup rollers 51 to 53, photoconductive members 2Y to 2K, developing rollers 3Y to 3K, mixers 4Y to 4K, an intermediate transfer belt 6, a fixing device 7, and a discharge tray 8.

The image processing apparatus according to this embodiment further includes a sound output unit 901 and a human sensor 902 (see FIG. 1). The sound output unit 901 includes a speaker and is arranged in the image forming unit P. The human sensor 902 includes an infrared ray sensor and detects presence of a user who is present near the image processing apparatus.

The image processing apparatus according to this embodiment includes a CPU 801 and a memory 802 (see FIG. 3). The CPU 801 has a role of performing various kinds of processing in the image processing apparatus. The CPU 801 also has a role of realizing various functions by executing programs stored in the memory 802. The memory 802 can be configured by, for example, a RAM (Random Access Memory), a ROM (Read Only Memory), a DRAM (Dynamic Random Access Memory), an SRAM (Static Random Access Memory), or a VRAM (Video RAM). The memory 802 has a role of storing various kinds of information and programs that are used in the image processing apparatus.

As an example of processing in the image processing apparatus according to this embodiment, an overview of copy processing is explained.

First, sheets picked up from cassettes by the pickup rollers 51 to 53 are fed into a sheet conveying path. The sheets fed into the sheet conveying path are conveyed in a predetermined conveying direction by plural roller pairs.

Images of plural sheet original documents automatically conveyed continuously by the auto document feeder 9 are scanned by the scanning optical system 10 in the predetermined image scanning position.

On the basis of image data of the images scanned from the original documents by the image scanning unit R, electrostatic latent images are formed on photoconductive surfaces of the photoconductive members 2Y, 2M, 2C, and 2K for transferring developer images of yellow (Y), magenta (M), cyan (C), and black (K) onto the sheets.

Subsequently, developers agitated by the mixers 4Y to 4K (equivalent to agitating units) in a developing device are supplied to the photoconductive members 2Y to 2K, on which the electrostatic latent images are formed as explained above, by the developing rollers (so-called mug rollers) 3Y to 3K. Consequently, the electrostatic latent images formed on the photoconductive surfaces of the photoconductive members 2Y, 2M, 2C, and 2K are visualized.

Developer images formed on the photoconductive members 2Y, 2M, 2C, and 2K in this way are transferred onto a belt surface of the intermediate transfer belt 6 (so-called primary transfer). The developer images carried according to the rotation of the intermediate transfer belt 6 are transferred on to the conveyed sheets in a predetermined secondary transfer position T.

The developer images transferred onto the sheets are heated and fixed on the sheets by the fixing device 7.

The sheets on which the developer images are heated and fixed are conveyed through a conveying path by the plural conveying roller pairs and sequentially discharged onto the discharge tray 8.

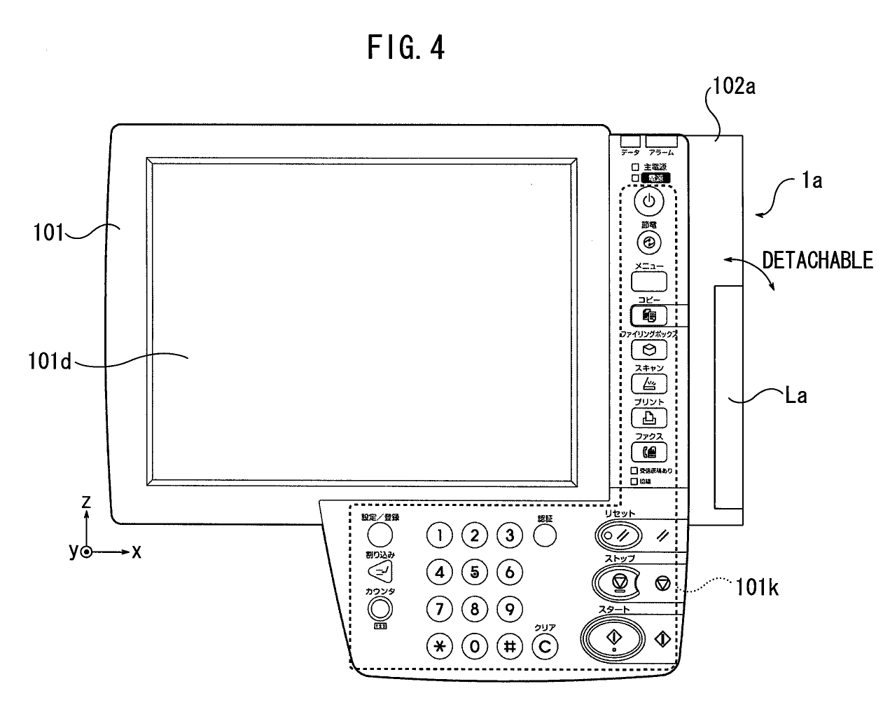

FIG. 4 is a diagram for explaining details of the operation input unit 1a in the first embodiment.

As shown in FIG. 4, the operation input unit 1a in this embodiment includes an operation input section 101 and a light source unit 102a.

Specifically, the operation input section 101 includes a display 101d that performs screen display for information concerning processing content in the image processing apparatus and operation input keys 101k that receive an operation input of the user.

The display 101d can be configured by, for example, an LCD (Liquid Crystal Display), an EL (Electro Luminescence) display, a PDP (Plasma Display Panel), or a CRT (Cathode Ray Tube).

The operation input keys 101k can be configured by a button group shown in FIG. 4. Besides, the operation input keys 101k can be configured by, a keyboard, a mouse, a touch panel, a touch pad, or a graphics tablet).

In this embodiment, the operation input keys 101k and the display 101d are separately provided independently from each other. However, the present invention is not limited to this. The functions of the operation input keys 101k and the display 101d can be realized by a so-called touch panel display.

The light source unit 102a is detachably attached to the right side of the operation input section 101 viewed from the front. The light source unit 102a has, as shown in FIG. 4, a light source La in a position further on a lower side than a center position in an up to down direction.

As the light source La, for example, an LED that can irradiate whitish illumination light, a fluorescent light, and electroluminescence can be adopted. However, the light source La only has to be a light source that can be used as a light source for illumination. The light source La is not limited to these light sources.

The light source unit 102a (the light source La) is supported together with the operation input section 101 by the supporting member 2 and the supporting member 3 and illuminates an area for work by the user in an image processing apparatus main body. Specifically, the light source La in this embodiment is set to illuminate a peripheral area of a sheet original document placed on the document placing table Rt.

The light source unit 102a is a unit detachably attachable to the operation input section 101 to be integrated with the operation input section 101.

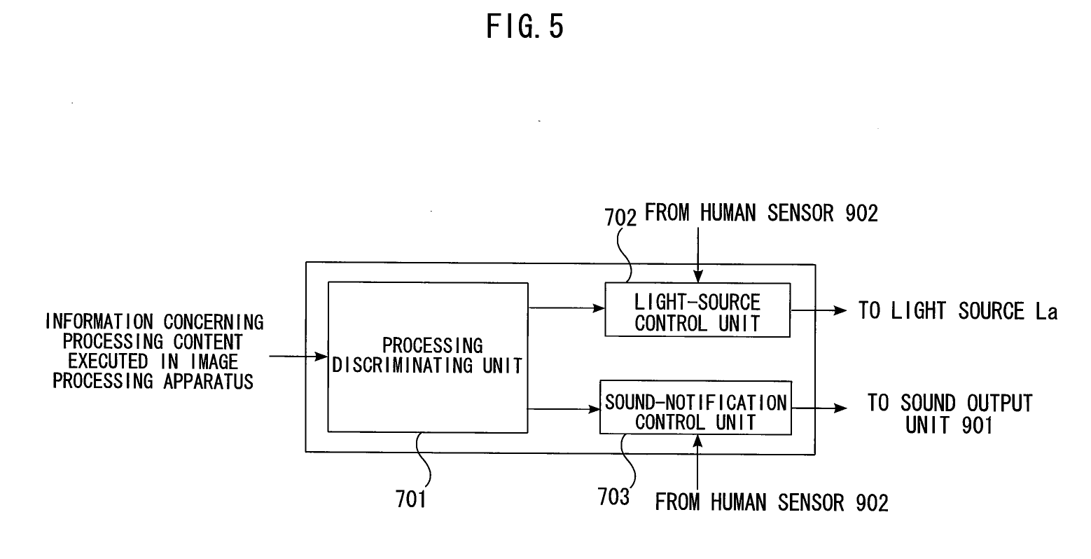

FIG. 5 is a functional block diagram for explaining the image processing apparatus according to this embodiment.

Specifically, the image processing apparatus according to the first embodiment includes a processing discriminating unit 701, a light-source control unit 702, and a sound-notification control unit 703.

First, the processing discriminating unit 701 discriminates content of processing executed in the image processing apparatus.

Specifically, the processing discriminating unit 701 discriminates whether the processing executed in the image processing apparatus corresponds to any one of various kinds of processing such as automatic document scanning processing performed by the image scanning unit R using an ADF, print processing by the image forming unit P, copy processing by the image scanning unit R and the image forming unit P, post-processing applied to a sheet having an image formed thereon by the post-processing apparatus F, and processing for coping with a sheet jam that occurs in the image processing apparatus (e.g., notification processing for requesting removal of a jammed sheet). By performing such discrimination processing by the processing discriminating unit 701, it is possible to realize appropriate illumination corresponding to processing content of the processing executed in the image processing apparatus.

The sound-notification control unit 703 causes the sound output unit 901 to output sound set in association with the content of the processing discriminated by the processing discriminating unit 701. Content of the sound output by the sound output unit 901 is stored in, for example, the memory 802 as sound data.

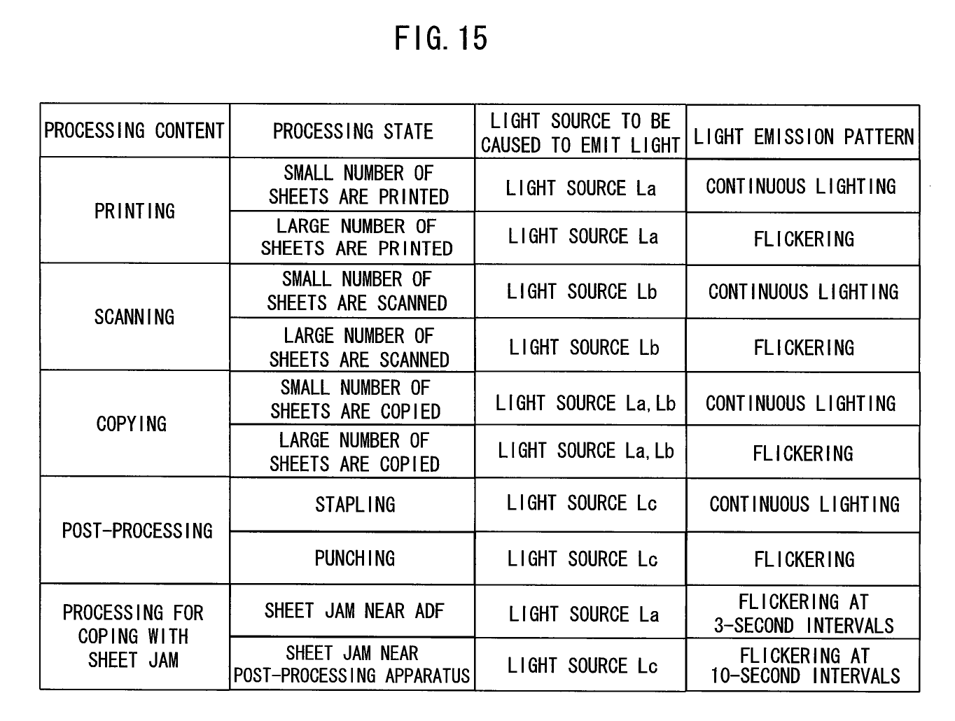

The light-source control unit 702 causes a light source, which should be caused to emit light, to emit light according to at least any one of the number of times of flickering, flickering speed (e.g., a flickering pattern set in advance), and luminance set in association with content of processing discriminated by the processing discriminating unit 701. Light emission content of the light source La controlled by the light-source control unit 702 is stored in, for example, the memory 802 as setting information for light emission control (see FIG. 15 referred to later).

In this embodiment, since the light source is provided only on the right side of the operation input section, the light-source control unit 702 causes the light source La to emit light only when a discrimination result by the processing discriminating unit 701 is the “automatic document scanning processing performed by the image scanning unit R using an ADF”.

The light-source control unit 702 can cause the light source La to emit light only when the human sensor 902 detects that the user is present around the image processing apparatus.

It goes without saying that, like the light-source control unit 702, the sound-notification control unit 703 can also cause the sound output unit 901 to perform sound output only when the human sensor 902 detects that the user is present around the image processing apparatus.

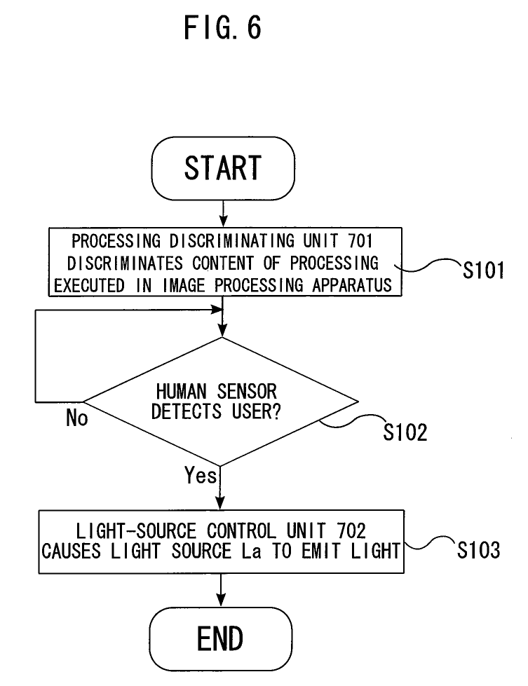

FIG. 6 is a flowchart for explaining a flow of processing (an operation support method) in the image processing apparatus according to this embodiment.

First, the processing discriminating unit 701 discriminates content of processing executed in the image processing apparatus (ACT 101).

When the human sensor 902 detects that the user is present around the image processing apparatus (ACT 102, Yes), the light-source control unit 702 causes, on the basis of a light emission pattern associated with the processing content discriminated by the processing discriminating unit 701, the light source La to emit light (ACT 103).

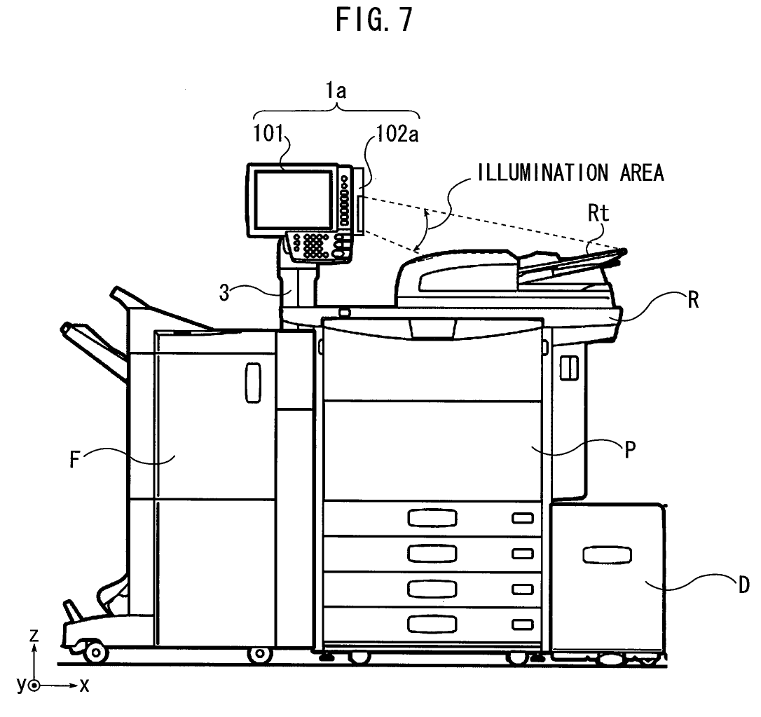

FIG. 7 is a diagram of a state in which the vicinity of the document placing table Rt of the image scanning unit R is illuminated by light irradiated from the light source La.

As explained above, according to the first embodiment of the present invention, it is possible to illuminate the vicinity of the auto document feeder and the document placing table Rt in the image scanning apparatus R. Therefore, it is possible to contribute to improvement of work efficiency in performing work such as alignment of an original document, check of the front and the back of the original document, and check of mislaying of the original document during copying.

### Second Embodiment

A second embodiment of the present invention is explained below.

The second embodiment is a modification of the first embodiment. The second embodiment is different from the first embodiment in a method of arranging a light source. Components same as those explained in the first embodiment are denoted by the same reference numerals and signs and explanation of the components is omitted.

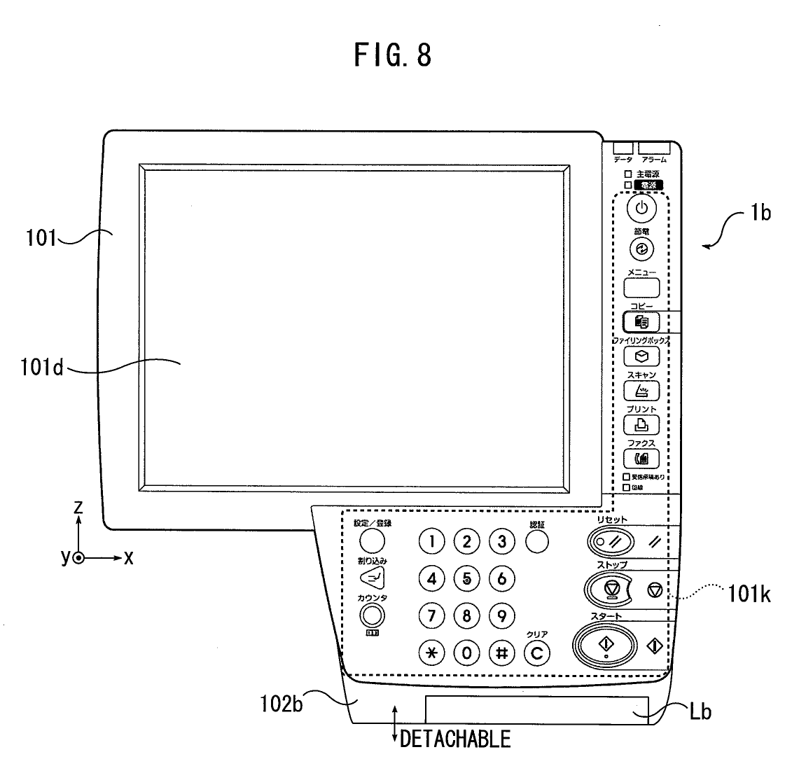

FIG. 8 is a diagram for explaining details of an operation input unit 1b in the second embodiment.

As shown in FIG. 8, the operation input unit 1b in this embodiment includes the operation input section 101 and a light source unit 102b.

The light source unit 102b is detachably attached to the lower end of the operation input section 101 viewed from the front. The light source unit 102b has, as shown in FIG. 8, a light source Lb in a position further on a right side than a center position in the left to right direction.

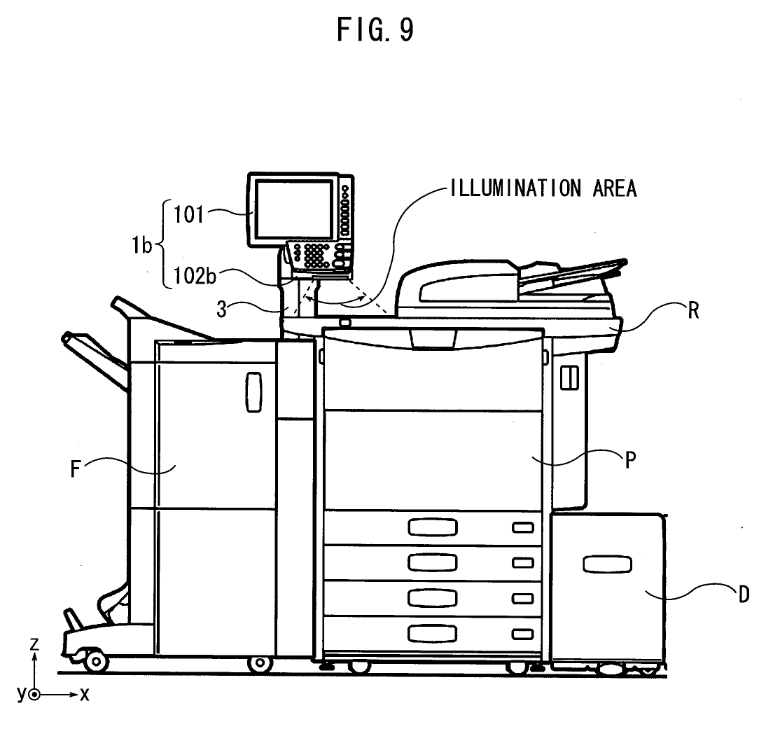

FIG. 9 is a diagram of a state in which the vicinity of the discharge tray 8 of the image forming unit P is illuminated by light irradiated from the light source unit 102b. As explained above, since the light source Lb is arranged further on the right side (i.e., in a position closer to the discharge tray 8), it is possible to illuminate a wider range in the vicinity of the discharge tray 8.

Consequently, a sheet subjected to image formation processing by the image forming unit P and discharged to the discharge tray 8 is illuminated by the light source unit 102b. Therefore, it is possible to prevent occurrence of mislaying of the sheet.

### Third Embodiment

A third embodiment of the present invention is explained below.

The third embodiment is a modification of the first and second embodiments. The third embodiment is different from the first and second embodiments in a method of arranging a light source. Components same as those explained in the first and second embodiments are denoted by the same reference numerals and signs and explanation of the components is omitted.

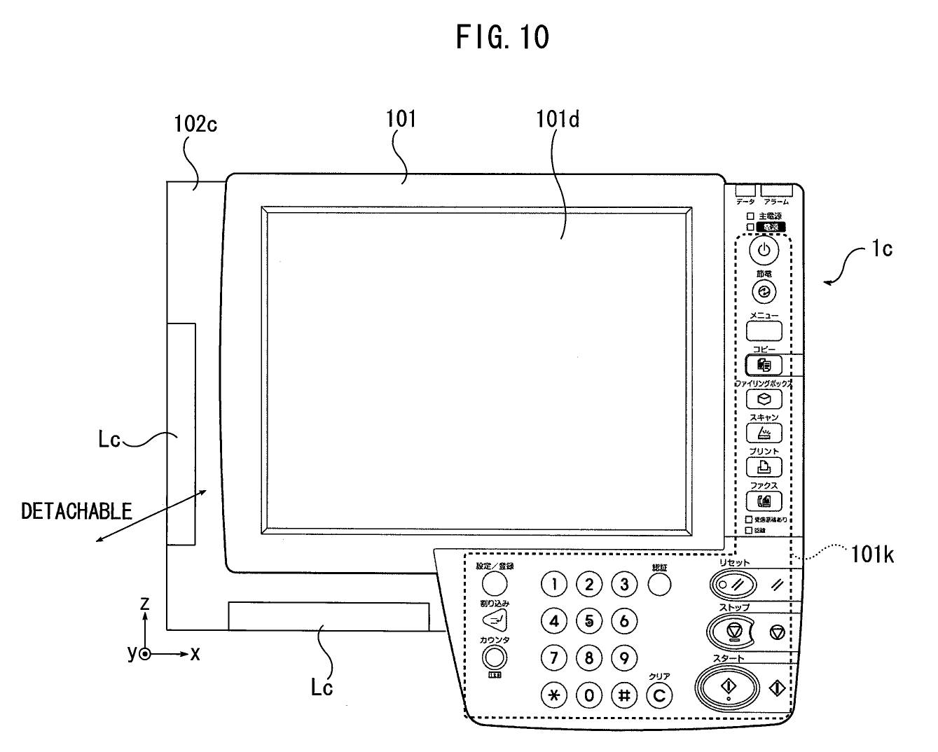

FIG. 10 is a diagram for explaining details of an operation input unit 1c in the third embodiment.

As shown in FIG. 10, the operation input unit 1c in this embodiment includes the operation input section 101 and a light source unit 102c.

The light source unit 102c is detachably attached to the left side and the lower end of the operation input section 101 viewed from the front. The light source unit 102c has, as shown in FIG. 10, light sources Lc on the left side and at the lower end of the operation input section 101 viewed from the front.

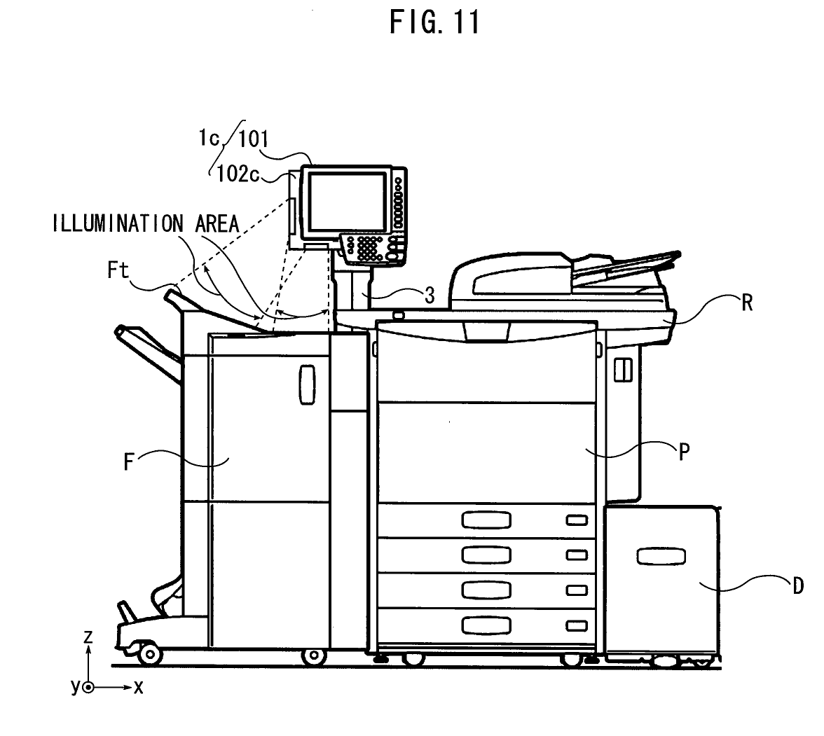

FIG. 11 is a diagram of a state in which the vicinity of a discharge tray Ft of the post-processing apparatus F is illuminated by light irradiated from the light source unit 102c. Since the light sources Lc are arranged as shown in the figure, a sheet subjected to predetermined post-processing by the post-processing apparatus F and discharged to the discharge tray Ft is illuminated by the light source unit 102c. Therefore, it is possible to realize check of a result of the post-processing and prevention of occurrence of mislaying of the processed sheet.

When a sheet jam occurs in the image processing apparatus according to this embodiment, it is possible to remove the sheet jammed in the image processing apparatus in a predetermined sheet removal position.

Therefore, by adjusting an arrangement position of the light source Lc, it is possible to illuminate a place (the predetermined sheet removal position) that is opened when the sheet jam in the image processing apparatus is solved. Further, it is possible to contribute to improvement of work efficiency in performing operation for solving the sheet jam (e.g., removal of the jammed sheet).

### Fourth Embodiment

A fourth embodiment of the present invention is explained below.

The fourth embodiment is a modification of the first to third embodiments. An image processing apparatus according to this embodiment includes all the light sources La to Lc in the first to third embodiments. Components same as those explained in the first to third embodiments are denoted by the same reference numerals and signs and explanation of the components is omitted.

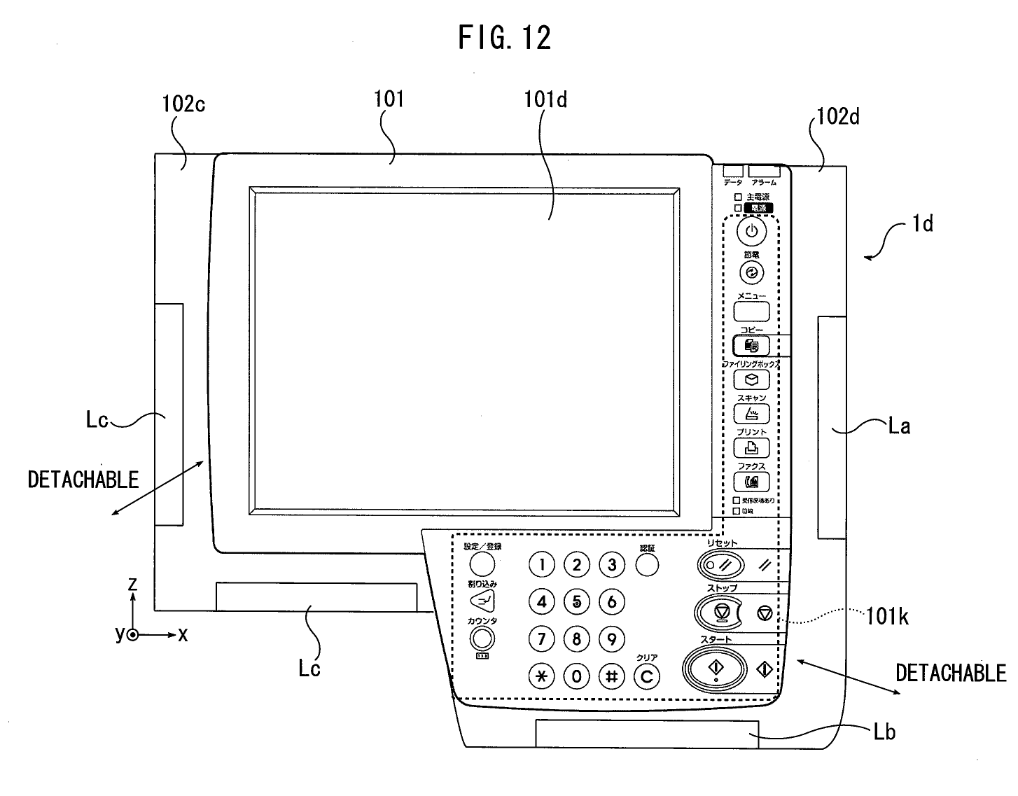

FIG. 12 is a diagram for explaining details of an operation input unit id in the fourth embodiment.

As shown in FIG. 12, the operation input unit 1d in this embodiment includes the operation input section 101, the light source unit 102c, and a light source unit 102d.

The light source unit 102c is detachably attached to the left side and the lower end of the operation input section 101 viewed from the front. The light source unit 102c has, as shown in FIG. 12, the light sources Lc on the left side and at the lower end of the operation input section 101 viewed from the front.

The light source unit 102d is detachably attached to the right side and the lower end of the operation input section 101 viewed from the front. The light source unit 102d is arranged in the same manner as the light source units explained in the first and second embodiments and has the light sources La and Lb.

In this way, the image processing apparatus according to this embodiment includes the plural light sources La, Lb, and Lc that can respectively illuminate areas for work different from one another.

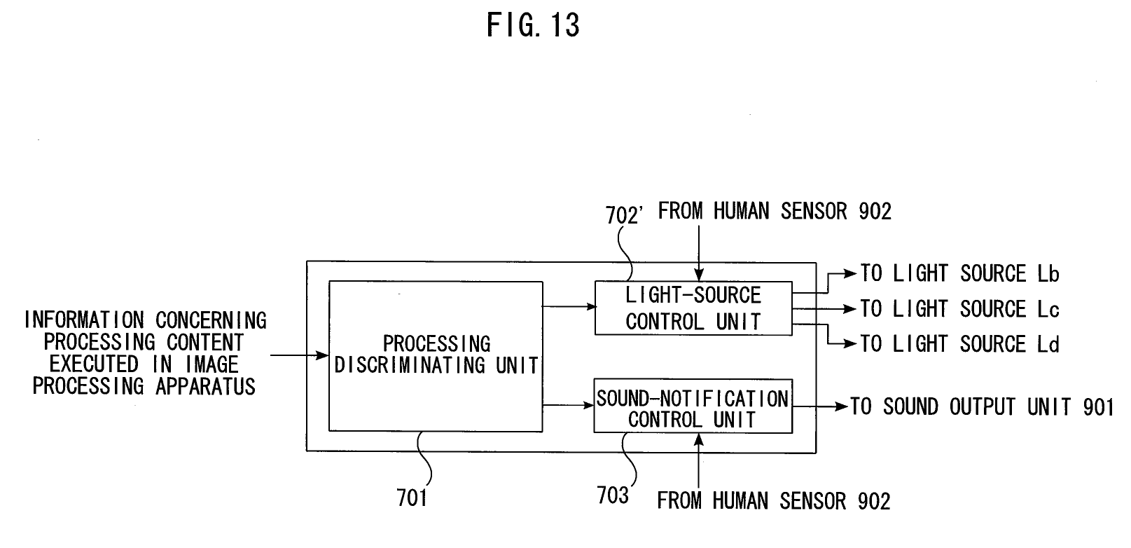

FIG. 13 is a functional block diagram for explaining a configuration of the image processing apparatus according to fourth embodiment.

A light-source control unit 702′ selectively causes the light sources associated with the areas for work related to processing discriminated by the processing discriminating unit 701 to emit light. Information concerning a correspondence relation between the discriminated processing and the light sources caused to emit light can be stored in, for example, the memory 802 as a data table (see FIG. 15 referred to later).

The “area for work” includes at least any one of the following:

(1) a position where a processing object to be subjected to image processing in the image processing apparatus is supplied to the image processing apparatus (e.g., the document placing table Rt);

(2) a position where the processing object subjected to the image processing in the image processing apparatus is output (e.g., the discharge tray 8); and

(3) an area to be operated during maintenance of the image processing apparatus (e.g., near an apparatus cover that can be opened).

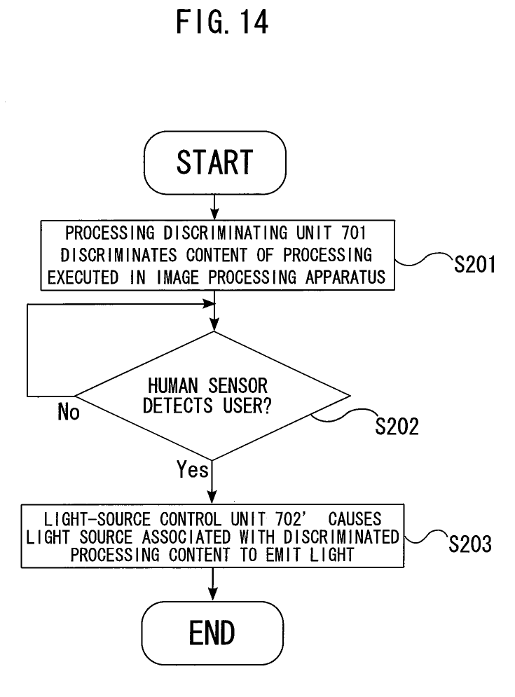

FIG. 14 is a flowchart of a flow of processing (an operation support method) in the image processing apparatus according to the fourth embodiment.

In the flowchart shown in the figure, processing contents in ACT 201 and ACT 202 are the same as those in ACT 101 and ACT 102 in the flowchart shown in FIG. 6. Therefore, explanation of the acts is omitted.

The light-source control unit 702′ selectively causes, on the basis of a light emission pattern or the like associated with processing content discriminated by the processing discriminating unit 701, the light source associated with the area for work related to the processing content discriminated by the processing discriminating unit 701 to emit light (ACT 203).

FIG. 15 is a diagram of an example of a data table in which a correspondence relation among processing content discriminated by the processing discriminating unit 701, a processing state, a light source that should be caused to emit light, and a light emission pattern is set.

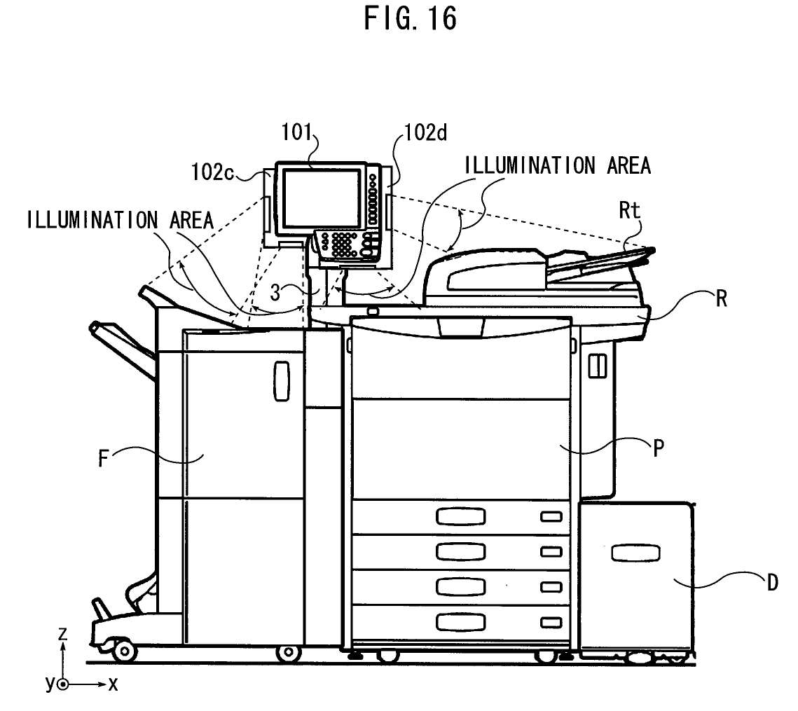

FIG. 16 is a diagram of a state in which all areas for work are illuminated by lights irradiated from the light source unit 102c and the light source unit 102d. The areas for work include the vicinity of the discharge tray Ft of the post-processing apparatus F, the vicinity of the discharge tray 8 of the image forming unit P, and the vicinity of the document placing table Rt of the image scanning unit R. In an example shown in the figure, all the light sources are caused to emit light in order to indicate areas that can be illuminated in this embodiment. However, it goes without saying that an arbitrary light source can be caused to emit light according to discriminated processing content.

By selecting an area to be illuminated according to content of processing executed on the image processing apparatus, it is possible to cause a user to be aware of a place that the user should watch carefully. Further, since an area that does not need to be illuminated is not uselessly illuminated, it is possible to contribute to a reduction in power consumption.

In an example explained in this embodiment, the plural light sources La, Lb, and Lc configuring the light source unit 102c and the light source unit 102d are light sources for white light. However, the present invention is not limited to this. For example, the plural light sources La, Lb, and Lc can also be configured to emit lights of colors different from one another.

Consequently, for example, it is also possible to associate processing content discriminated by the processing discriminating unit and an emitted light color, and, in illuminating an area for work highly necessary to be illuminated, use the light source that can perform illumination in a red emitted light color and, in illuminating an area for work not so highly necessary to be illuminated, use the light source that can perform illumination in a blue emitted light color. It goes without saying that it is possible to configure each of the plural light sources La, Lb, and Lc to be capable of emitting light in plural colors and select an emitted light color according to processing content (a processing type such as image formation processing, image scanning processing, copy processing, or processing for coping with a sheet jam) discriminated by the processing discriminating unit and a processing state (processing speed, a processed amount, an amount scheduled to be processed, urgency, etc.).

The light source unit in each of the embodiments explained above is detachably attachable to the operation input section 101. This makes it possible to remove the light source unit from the operation input section 101 as a unit and illuminate the inside or the like of the apparatus main body that needs to be illuminated when a sheet jam or the like occurs. In the example explained in each of the embodiments, when a sheet jam occurs in the image processing apparatus, the light source unit that can illuminate the vicinity of an area required to be operated in order to solve the sheet jam is caused to perform illumination. However, the present invention is not always limited to this.

For example, when it is determined that a sheet jam occurs in the image processing apparatus, in order to allow the user to remove the light source unit detachably attachable to the operation input section 101 and use the light source unit for illumination, such a detachable light source unit may be selectively caused to emit light.

For example, the light source unit detachably attachable to the operation input section 101 may receive power supply from the apparatus main body via a power supply cord or may be loaded with a secondary battery.

In the example explained in each of the embodiments, the light source mounted on the light source unit is provided as an illumination device exclusively used for illuminating the area for work. However, the present invention is not always limited to this. For example, a part of a backlight or the entire backlight of the display 101d provided in the operation input section 101 may also be used as a light source. A part of light irradiated from the backlight may be led to the outside from a gap of a casing of the operation input section 101 and used as illumination light for illuminating the area for work.

In the example explained in the fourth embodiment, the light source caused to emit light among the plural light sources is selected on the basis of a discrimination result in the processing discriminating unit. Besides, it is also possible to exceptionally set a specific light source to always emit light according to brightness or the like of a setting environment.

In each of the embodiments, the light source unit and the operation input section are integrally supported by the supporting member. However, the present invention is not always limited to this. For example, it is also possible to adopt a configuration for individually coupling the light source unit and the operation input section to the supporting member.

The acts in the processing (the operation support method) in the image processing apparatus according to each of the embodiments can be realized by causing the CPU 801 to execute an operation support program stored in the memory 802.

Further, a program for causing a computer configuring the image processing apparatus to execute the acts can be provided as the operation support program. In the example explained in each of the embodiments, the program for realizing the functions for carrying out the invention is recorded in advance in a storage area provided in the apparatus. However, the present invention is not limited to this. The same program may be downloaded from a network to the apparatus. The same program stored in a computer-readable recording medium may be installed in the apparatus. A form of the recording medium may be any form as long as the recording medium can store the program and is a computer-readable recording medium. Specifically, examples of the recording medium include internal storage devices implemented in the computer such as a ROM and a RAM, portable storage media such as a CD-ROM, a flexible disk, a DVD disk, a magneto-optical disk, and an IC card, a database that stores a computer program, other computers and databases for the computers, and a transmission medium on a line. Functions obtained by the installation and the download in this way in advance may realize the functions in cooperation with an OS (operating system) in the apparatus.

The program in the embodiments includes a program for dynamically generating an execution module.

The present invention is explained above in detail with reference to the specific embodiments. However, it would be obvious to those skilled in the art that various modifications and alterations are possible without departing from the spirit and the scope of the present invention.

As explained above in detail, according to the present invention, it is possible to provide a technique that can maintain satisfactory operability with a simple configuration regardless of brightness of an environment in which an image processing apparatus is set.

What is claimed is:

1. An image processing apparatus comprising:
an operation input section that receives an operation input of a user;
a supporting member that supports the operation input section in a position away from an apparatus main body; and
a light source that is supported together with the operation input section by the supporting member and illuminates an area for work by the user in the apparatus main body.

2. The apparatus according to claim 1, wherein the area for work includes at least any one of a position where a processing object to be subjected to image processing in the apparatus is supplied to the apparatus, a position where the processing object subjected to the image processing in the apparatus is output, and an area to be operated during maintenance of the apparatus.

3. The apparatus according to claim 1, wherein the light source is arranged at least one of a side and a bottom of the operation input section.

4. The apparatus according to claim 1, wherein
a plurality of the light sources are provided, and
the plural light sources respectively illuminate areas for work different from one another.

5. The apparatus according to claim 4, further comprising:
a processing discriminating unit that discriminates content of processing executed in the apparatus; and
a light-source control unit that causes a light source associated with an area for work related to the processing discriminated by the processing discriminating unit to emit light.

6. The apparatus according to claim 5, wherein the light-source control unit causes the light source, which should be caused to emit light, to emit light according to at least one of a number of times of flickering, flickering speed, and luminance set in association with the content of the processing discriminated by the processing discriminating unit.

7. The apparatus according to claim 5, further comprising:
a sound output unit that performs sound output; and
a sound-notification control unit that causes the sound output unit to output sound set in association with the content of the processing discriminated by the processing discriminating unit.

8. The apparatus according to claim 1, wherein
the apparatus forms an image on a sheet and discharges the sheet having the image formed thereon onto a discharge tray, and
the light source is arranged to be capable of illuminating the sheet discharged onto the discharge tray.

9. The apparatus according to claim 1, wherein
the apparatus automatically feeds an original document placed on a predetermined document placing table and scans an image of the original document, and
the light source is arranged to be capable of illuminating the original document placed on the predetermined document placing table.

10. The apparatus according to claim 1, wherein
the apparatus applies any one kind of post-processing among stapling, folding, punching, and bookbinding to a sheet subjected to predetermined image formation processing and discharges the sheet subjected to the post-processing onto a discharge tray, and
the light source is arranged to be capable of illuminating the sheet discharged onto the discharge tray.

11. The apparatus according to claim 1, wherein
when a sheet jam occurs in the apparatus, the apparatus can remove a sheet jammed in the apparatus in a predetermined sheet removal position, and
the light source is arranged to be capable of illuminating the predetermined sheet removal position.

12. The apparatus according to claim 1, wherein at least a part of the supporting member extends to above the apparatus.

13. The apparatus according to claim 1, further comprising a human sensor that detects presence of a user present near the apparatus, wherein
the light-source control unit causes the light source to emit light only when the human sensor detects the user.

14. The apparatus according to claim 1, wherein
the operation input section has a display screen for displaying information concerning processing content in the apparatus, and
the light source is a backlight of a display screen in the operation input section.

15. The apparatus according to claim 1, wherein the light source is at least one of an LED, a fluorescent light, and electroluminescence.

16. The apparatus according to claim 1, wherein the light source is supported integrally with the operation input section by the supporting member and formed as a unit to be detachably attachable to the operation input section.

17. An operation support method in an image processing apparatus including an operation input section that receives an operation input of a user, a supporting member that supports the operation input section in a position away from an apparatus main body, and a light source that is supported together with the operation input section by the supporting member and illuminates an area for work by the user in the apparatus main body,
the method comprising:
discriminating content of processing executed in the image processing apparatus; and
causing a light source associated with an area for work related to the discriminated processing to emit light.

18. The method according to claim 17, wherein the area for work includes at least any one of a position where a processing object to be subjected to image processing in the image processing apparatus is supplied to the image processing apparatus, a position where the processing object subjected to the image processing in the image processing apparatus is output, and an area to be operated during maintenance of the image processing apparatus.

19. An operation support program for causing a computer to execute an operation support method in an image processing apparatus including an operation input section that receives an operation input of a user, a supporting member that supports the operation input section in a position away from an apparatus main body, and a light source that is supported together with the operation input section by the supporting member and illuminates an area for work by the user in the apparatus main body,
the program causing the computer to execute processing for:
discriminating content of processing executed in the image processing apparatus; and
causing a light source associated with an area for work related to the discriminated processing to emit light.

20. The program according to claim 19, wherein the area for work includes at least any one of a position where a processing object to be subjected to image processing in the image processing apparatus is supplied to the image processing apparatus, a position where the processing object subjected to the image processing in the image processing apparatus is output, and an area to be operated during maintenance of the image processing apparatus.
